(19) United States
(12) Patent Application Publication
(10) Pub. No.: US 2026/0043369 A1
(43) Pub. Date: Feb. 12, 2026

(54) METHOD FOR DETERMINING A FLOW RATE OF FLUID IN A VEHICLE ENGINE SYSTEM

(71) Applicant: VITESCO TECHNOLOGIES GmbH, Regensburg (DE)

(72) Inventors: Nicolas LAMARQUE, Toulouse (FR); Michael LEBLON, Toulouse (FR)

(21) Appl. No.: 19/099,451

(22) PCT Filed: Sep. 13, 2023
(86) PCT No.: PCT/EP2023/075097

§ 371 Date: Jan. 28, 2025

(30) Foreign Application Priority Data
Sep. 22, 2022 (FR) FR2209609

(51) Int. Cl. F02D 41/22; F02D 41/24; F02D 41/40

(52) U.S. Cl. CPC F02D 41/221; F02D 41/2467; F02D 41/40; F02D 2041/224; F02D 2200/0614

(57) ABSTRACT

A system and method for determining a value of a flow rate of a liquid in a vehicle engine system comprising a fluid tank (3), a pump (2), a fluid injector (1), with a fluid flow path from the pump to an injected zone (4), and an electronic control unit (5) for controlling opening of the injector, the method comprising:—providing a loss estimation module (52), supplying as output a hydraulic loss coefficient (CP),—carrying out a plurality of sequences of fluid injection, with values of a plurality of parameters (dP, P1, P0, T, X) being collected,—calculating a theoretical quantity (QTH) of fluid injected during these injection sequences, with the aid of the values of the parameters (P1, P0, T, X),—calculating an estimated actual quantity (QRE) of fluid injected during the injection sequences, by applying the loss coefficient (CP) to the calculation of the theoretical quantity of fluid.

### TECHNICAL FIELD AND CONTEXT

The present invention relates to methods for determining a fluid flow rate, in particular a liquid flow rate, in a vehicle engine system, in particular when said flow rate is not measured directly by a sensor. In this case, it is necessary to estimate said flow rate (or a quantity delivered) from other information and/or other parameters. The present invention is particularly useful when the system comprises an electronically controlled injector, the orifice of which may be subject to deposits or clogging and a reduction in the effective flow cross section, or which undergoes wear (an increasing flow cross section).

### PRIOR ART

It is known, by virtue of at least one pressure sensor, to monitor the change in the pressure over time during a control sequence of the injector. Thus, the temporal characteristics of the pressure in the line and the smoothed values of the pressure and other parameters such as the temperature are recorded. Furthermore, during the development of the system, calibration tables are constructed depending on the effective flow cross section of the injector and the different parameters mentioned above.

The use of these calibration tables and of conventional algorithmic logic makes it possible to estimate the actual flow rate delivered by an injector, the characteristics of which may change over time, and in particular the flow cross section can decrease on account of gradual clogging, or increase again if a crystallized deposit disappears.

Among the systems of interest here, there are “selective catalytic reduction” (SCR) systems, which reduce the emissions of nitrogen oxides. However, the invention may be applied to other systems for injecting liquid, in particular fuel, when the control is open-loop control. For example, the invention may be applied to a gasoline injection system in which the richness looping is currently not operating.

The inventors have sought to improve the situation by doing away with the tedious step of constructing the calibration tables.

### SUMMARY OF THE INVENTION

To this end, according to the present disclosure, a method for determining at least one value of a flow rate of a fluid of interest in an engine system of a vehicle of interest is proposed, said flow rate value not being measured directly by a sensor, the engine system comprising at least a fluid tank, a pump, a fluid injection member, with a fluid flow path from the pump to an injected zone downstream of the injection member, and an electronic control unit that is able to command opening of the injection member, which is otherwise closed in the absence of a command, the fluid of interest advantageously being a liquid fluid that may be considered to be incompressible, the method comprising the following steps:
providing a loss estimation module, supplying as output a hydraulic loss coefficient CP,
/b/—carrying out a plurality of N sequences of fluid injection, during which values of a plurality of parameters (dP, P1, P0, T, X) are collected,
/c/—calculating a theoretical quantity of fluid injected during these N sequences of fluid injection, with the aid of at least some of said values of the plurality of parameters (P1, P0, T, X),
/d/—transmitting, to the loss estimation module, said values of the plurality of parameters (dP, P1, P0, T, X), and obtaining, at the output of the loss estimation module, the loss coefficient CP,
/e/—calculating an estimated actual quantity of fluid injected during the N sequences of fluid injection, by applying the loss coefficient CP to the calculation of the theoretical quantity of fluid.

By virtue of these provisions, the theoretical quantity calculated can be corrected by means of the output of the loss estimation module in order to determine the quantity actually injected as closely as possible. As will be shown below, the loss estimation module may be a supervised-learning loss estimation module, for example of the neural network type. The learning was able to be carried out in advance, prior to the effective use by the above-described method.

The invention makes it possible to determine a flow rate and/or a quantity of injected fluid, the two quantities being linked simply by a time that has elapsed in order to inject said quantity of fluid.

Note that steps c/and d/can be implemented in parallel. Regarding the parameter values, in practice, use is made of the values averaged over the plurality of the N sequences (or the median), and the method is thus robust to one or two occasional erroneous values.

According to one aspect, the loss estimation module may be a supervised-learning loss estimation module, the method then comprising a prior step:
/a/—carrying out, in advance, a learning operation of the supervised-learning loss estimation module (52) by means of a series of test injection members having known flow cross section characteristics, which are placed successively as injection member on a similar flow path of a test vehicle in order to simulate the hydraulic loss introduced by the injection member on the flow path in the vehicle of interest depending on the plurality of parameters, and while measuring, during an opening sequence of the test injection member, the values of the parameters of the plurality of parameters, the loss estimation module taking as input said plurality of parameters (dP, P1, P0, T, X) and supplying as output the hydraulic loss coefficient CP.

Note that the learning (step /a/) does not necessarily take place on the same vehicle as the following steps (/b/ to /e/). In other words, in practice, the learning is typically carried out on a particular test vehicle in which these learning tests can be implemented, and step /b/and the subsequent steps will be carried out on series vehicles that are manufactured and sold in large numbers and used by a large number of drivers under various conditions and for long use times including effects associated with wear and aging. Note also that the test injection members may have a flow cross section that is smaller than the nominal flow cross section, or, conversely, a flow cross section that is larger than the nominal flow cross section.

According to one aspect, the theoretical calculation uses a so-called Bernoulli model for an incompressible fluid.

For example, it is possible to choose a formulation of the following type:

$$QTH = N Ti \sqrt{ρ ( P 1 - P 0 )} A , \qquad [ Math 1 ]$$

where ρ is the density of the fluid, P1 is the pump output pressure, P0 is the pressure in the injected zone 4, A is a characteristic section of the flow cross section, Ti is the injection duration, and N is the number of injections.

According to one aspect, provision may be made, in step /e/, for the loss coefficient CP to be applied by multiplying it by the calculation of the theoretical quantity of fluid in order to obtain the estimated actual quantity of fluid injected during the N sequences of fluid injection.

However, rather than a simple multiplication, it is possible to take into account certain nonlinear effects by applying a nonlinear function of the type QRE=F(QTH, CP).

A person skilled in the art will understand that a hydraulic loss coefficient is related to a pressure drop, or hydraulic pressure drop, introduced here by the flow circuit formed by the fluid injection member.

The loss coefficient CP may be between 0 and 1. This corresponds, for example, to the case in which the section is reduced and the actual quantity is less than the theoretical quantity QTH.

However, the invention also takes into account the opposite case, in which the actual quantity is greater than the theoretical quantity, i.e. the cases in which CP is greater than 1. As a generalization of the invention, the loss coefficient may be considered to be a correction coefficient (e.g. characterizing either a loss or an excess). Specifically, it will be understood that this hydraulic loss coefficient may be relevant for only the variations therein over time, which express a variation in the fluid flow conditions in the fluid injection member.

According to one aspect, an alert is activated if the loss coefficient CP is below a predetermined threshold CPS1, which is preferably between 0.5 and 0.75. A deposit substantially blocking the orifice or orifices may require verification of the system in a garage or even replacement of a part or component.

According to one aspect, an alert is activated if the loss coefficient CP is above a second predetermined threshold, which is preferably between 1.1 and 1.2. This may denote a mechanical fault which may require a repair.

According to yet another variant, an alert is activated if a variation in the loss coefficient CP is above a predetermined threshold for a predetermined number M of injections.

It will therefore be understood that the calculation of the hydraulic loss coefficient and/or the change therein over time makes it possible to diagnose an anomaly in the hydraulic circuit formed by the fluid injection member.

In one aspect, the loss estimation module comprises a neural network. The neural network may have a size less than 5 kilobytes and preferably less than 3 kilobytes. According to one aspect, the loss estimation module comprises a neural network, comprising around one hundred to several hundred neurons. By way of example, the neural network in question may comprise fewer than 500 neurons, or even preferably fewer than 400 neurons. The memory involved thus has a small size.

According to one aspect, the values of the plurality of parameters (dP, P1, P0, TKi, X) are filtered and/or smoothed over the N injection sequences for use in the loss estimation module. For each parameter, it is thus possible to calculate the average of the values observed, or the median of the values observed. This confers robustness on the method in relation to potential isolated aberrant values.

According to one aspect, the plurality of parameters (dP, P1, P0, TK, X) comprises a first parameter (dP) representative of an increase in pressure on closure of the injector (“water hammer” in hydraulic jargon).

The invention also relates to a system for determining at least one value of a flow rate of a fluid of interest, this fluid of interest flowing in use in an engine system of a vehicle of interest, said flow rate value not being measured directly by a sensor, the engine system comprising at least a fluid tank, a pump, a fluid injection member, with a fluid flow path from the pump to an injected zone downstream of the injection member, and an electronic control unit that is able to command opening of the injection member, which is otherwise closed in the absence of a command, the fluid of interest being a liquid fluid that is incompressible or exhibits low compressibility,
the system comprising a hydraulic loss estimation module, supplying as output a hydraulic loss coefficient CP,
the electronic control unit being configured for:
/b/—carrying out a plurality of N sequences of fluid injection, during which values of a plurality of parameters (dP, P1, P0, T, X) are collected,
/c/—calculating a theoretical quantity of fluid injected during these N sequences of fluid injection, with the aid of at least some of said values of the plurality of parameters (P1, P0, T, X),
/d/—transmitting, to the loss estimation module, said values of the plurality of parameters (dP, P1, P0, T, X), and obtaining, at the output of the loss estimation module, the loss coefficient CP,
/e/—calculating an estimated actual quantity of fluid injected during the N sequences of fluid injection, by applying the loss coefficient CP to the calculation of the theoretical quantity of fluid.

By virtue of these provisions, for the system as for the method, the theoretical quantity calculated can be corrected by means of the output of the loss estimation module in order to determine the quantity actually injected as closely as possible. The learning was able to be carried out in advance, prior to the effective use by the above-described system.

Note that steps c/ and d/ can be implemented in parallel. Regarding the parameter values, in practice, use is made of the values averaged over the plurality of the N sequences (or the median), and the method is thus robust to one or two occasional erroneous values.

According to one aspect, the loss estimation module may be a supervised-learning loss estimation module, the method then comprising a prior step:
/a/—carrying out, in advance, a learning operation of the supervised-learning loss estimation module by means of a series of test injection members having known flow cross section characteristics, which are placed successively as injection member on a similar flow path of a test vehicle in order to simulate the hydraulic loss introduced by the injection member on the flow path in the vehicle of interest depending on the plurality of parameters, and while measuring, during an opening sequence of the injection member, the values of the parameters of the plurality of parameters, the loss estimation module taking as input said plurality of parameters (dP, P1, P0, TK, X) and supplying as output the hydraulic loss coefficient CP.

The learning conditions are identical or similar to the description given above.

According to one aspect, the fluid may be a urea-based liquid intended to reduce nitrogen oxides. The invention is thus applicable to the “selective catalytic reduction” (SCR) systems, which reduce the emissions of nitrogen oxides.

According to another possibility, the fluid may be a fuel or hydrocarbon intended to be combusted in an internal combustion engine.

According to one aspect, the injection member is a needle injector. Such an injector can deliver a small quantity of liquid with great precision. Such a needle injector has a coil which creates an electromagnetic force when an electric current generated by an electronic control unit passes through it. Control that is flexible and adaptable to the various operating conditions is thus provided.

According to one aspect, the loss estimation module may be in the form of a neural network contained in the electronic control unit. This solution is readily available and advantageous since it saves on calculation and memory resources.

The invention also covers a diagnostic method for an engine system of a vehicle of interest, the engine system comprising at least a fluid tank, a pump, a fluid injection member, with a fluid flow path from the pump to an injected zone downstream of the injection member, and an electronic control unit that is able to command opening of the injection member, which is otherwise closed in the absence of a command,
the method comprising the following steps:
   providing a supervised-learning loss estimation module, taking as input a plurality of parameters and supplying as output a hydraulic loss coefficient CP relating to a hydraulic loss introduced by the fluid injection member,
/b/—carrying out a plurality of N sequences of fluid injection, during which values of said plurality of parameters are collected,
/d/—transmitting, to the loss estimation module, said values of the plurality of parameters, and obtaining, at the output of the loss estimation module, the loss coefficient CP,
/e′/ comparing the loss coefficient CP with a predetermined value, and generating an alert if the difference in absolute value exceeds a predetermined threshold.

It is thus possible to carry out predictive maintenance by anticipating a need for repair and/or replacement at the fluid injection member.

Said predetermined value is advantageously an initial value of the loss coefficient CP, optionally an averaged value, obtained at the start of life of the fluid injection member, when the latter has not yet undergone wear or clogging. The predetermined threshold corresponds preferably to a difference of plus or minus 30%, or plus or minus 20%, between the current value of the loss coefficient CP and said predetermined value corresponding advantageously to an initial value of the loss coefficient CP.

The detailed information above relating to the method for determining an injected quantity of a fluid of interest also applies to the diagnostic method for an engine system of a vehicle of interest. Specifically, the two methods share one and the same basic concept, consisting in estimating, with the aid of a supervised-learning loss estimation module, a loss coefficient relative to a hydraulic loss introduced by the fluid injection member.

The invention also covers a corresponding diagnostic system for an engine system of a vehicle of interest.

Further aspects, aims and advantages of the invention will become apparent upon reading the following description of an embodiment of the invention, which is provided by way of a nonlimiting example. The invention also will be understood better with reference to the accompanying drawings, in which:

FIG. 1 schematically illustrates a liquid injection system employing a controlled injector,

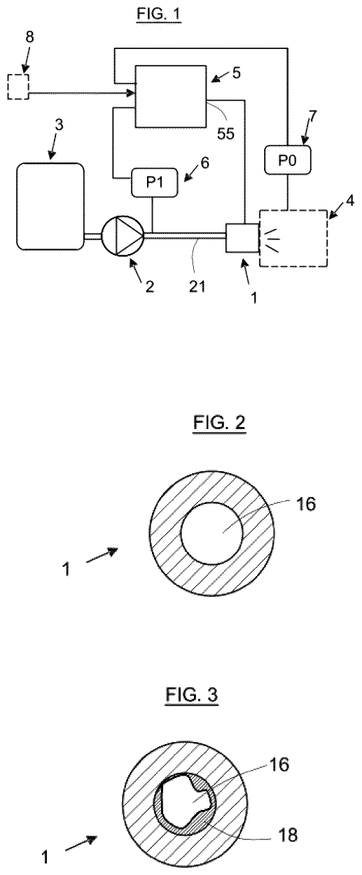

FIG. 2 schematically shows an injector having nominal characteristics,

FIG. 3 schematically shows an injector hole exhibiting the presence of deposits reducing the flow cross section,

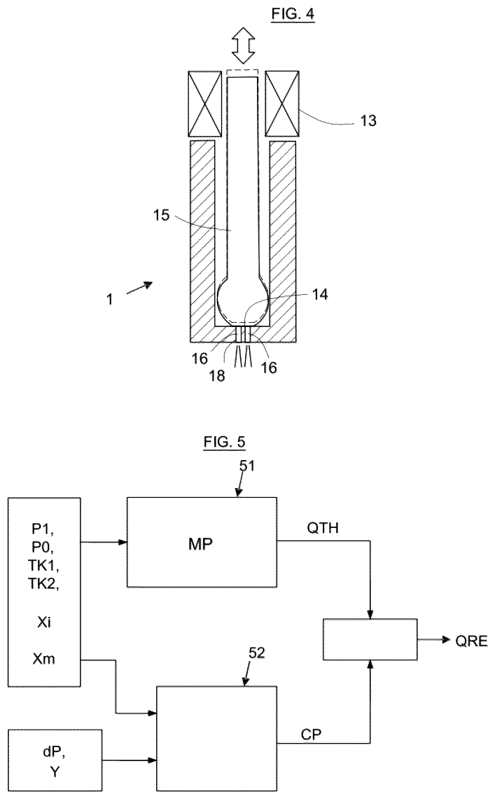

FIG. 4 schematically shows a cross section through an injection member,

FIG. 5 shows a functional block diagram of the system,

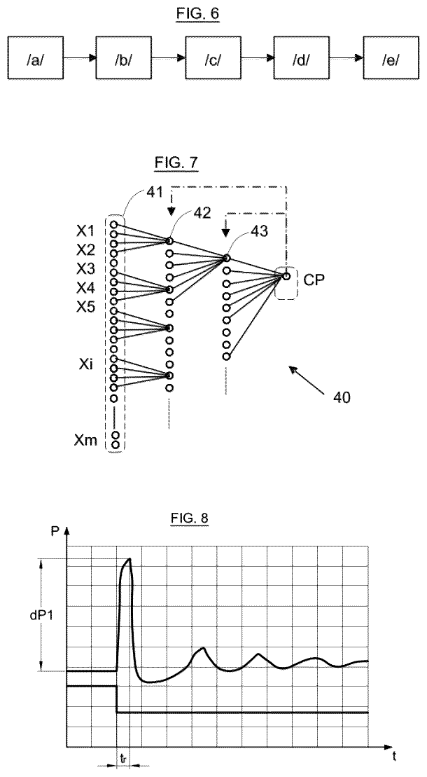

FIG. 6 shows an illustration of the steps of the method,

FIG. 7 schematically shows an example of a supervised-learning neural network,

FIG. 8 shows a pressure chronogram illustrating a jump in pressure observed when the injection member is closed.

### DETAILED DESCRIPTION OF EMBODIMENTS

In the various figures, the same reference signs have been used to denote identical or similar elements. For the sake of the clarity of the disclosure, some elements are not necessarily shown to scale.

Of interest are the systems and methods for determining a fluid flow rate, in particular a liquid flow rate, in a vehicle engine system, in particular when said flow rate is not measured directly by a sensor. The vehicle in question may be an automobile, a truck, a scooter; the invention may be applied without limitation as to the type of vehicle or the engine type thereof, for example to a motorboat.

The flow rate and/or the quantity of liquid fluid delivered by an injection member have to be estimated on the basis of other information and/or other parameters.

The injection member in the present invention is an electronically controlled injector. The injection member may be put into an open state when it is excited by an electrical command supplied by an electronic control unit. Furthermore, in the absence of an electrical command, the injection member is closed.

For example, with reference to FIG. 4, a needle 15 that is movable with respect to an orifice seat 14 may be provided. In the absence of an electrical command, the needle bears on the seat, the needle thus closing off the orifice 16 (or the orifices), and the injection member is closed. In the presence of an electrical command, the needle is lifted from the seat, the needle thus opening up a passage through the orifice (or the orifices), and the injection member is said to be open.

The orifice (or the orifices) 16 in the injection member or the abovementioned seat may be subject to occurrences of clogging or solid deposits 18 that reduce the flow cross section, cf. FIG. 3.

Conversely, erosion of the walls of the orifice (or of the orifices) may be observed in certain cases, increasing the flow cross section. This erosion may be caused by cavitation or deterioration of the material.

In the example illustrated, the fluid of interest is a liquid fluid. The liquid fluid is considered to be incompressible here. Generally, the liquid fluid may exhibit low compressibility.

According to one example, the fluid of interest is a urea-based liquid intended to reduce nitrogen oxides in an abovementioned so-called “SCR” system. The urea-based liquid is injected into a catalytic reducer.

According to another example, the fluid of interest is a hydrocarbon-based liquid intended to be injected into a combustion chamber.

As illustrated in FIG. 1, the engine system involved in the present invention comprises at least a fluid tank 3, a pump 2, and a fluid injection member 1 of the abovementioned type. A pipe 21 is provided for fluidically connecting the outlet of the pump to the injection member so as to channel the fluid under pressure P1 from the pump to the injection member 1.

Thus, a fluid flow path from the pump to an injected zone 4 downstream of the injection member is defined. The pressure that prevails downstream of the injection member is denoted PO.

### System-General Information

The system also comprises an electronic control unit 5 that is able to command opening of the injection member. In the case of a needle injector 15, the electronic control unit 5 controls an injector coil 13.

The pump 2 may be incorporated into the tank 3. Alternatively, the pump 2 may be separate from the tank.

A pressure sensor 6 for measuring the pressure P1 at the pump outlet is provided. This pressure sensor is arranged at the pump outlet or on the pipe 21.

In intended applications of the SCR type, the pressure P1 is between 2 bar and 8 bar. In other applications, the pressure P1 may be between 5 bar and 100 bar. Higher pressures are not excluded from the field of application of the present invention either, for example up to 500 bar.

According to one implementation, the pump 2 is controlled in a permanent mode, i.e. it runs before the injector is controlled and continues to run while the injector is being controlled, and even after the injector has been controlled. According to another implementation, the pump is controlled in a so-called “on-demand” mode, i.e. just before and during the injector control cycle.

For example, for the SCR application, it is customary to provide a group of multiple injection cycles that are close together in time in order to generate combustion of the nitrogen oxides. Following this, the filter is regenerated and it is no longer necessary to inject urea; consequently, the injector may remain closed at rest for a time of several minutes or a distance traveled by the vehicle of several kilometers. Therefore, the pump may remain stopped between the groups of injection cycles.

Another pressure sensor 7 for measuring the pressure P0 in the injected zone is provided.

Optionally, a temperature sensor 8 for measuring the temperature of the fluid, for example the temperature of the fluid in the tank 3, is provided.

In a first configuration, the pipe 21 supplies a single injection member.

In a second configuration, the pipe 21 forms a manifold and supplies a plurality of injection members, which are controlled in a sequential mode, i.e. one at a time.

The pipe 21 does not have a member for directly measuring a liquid flow rate or a quantity delivered by the injection member.

Of interest in the following text is the way of best determining a value of a flow rate of the fluid of interest in a vehicle of interest. In one example, the vehicle of interest is a particular vehicle from a set of vehicles series-manufactured in average or large quantities. Found in this vehicle of interest is the above-described engine system with a tank, pump and injection member(s).

Moreover, the electronic control unit 5 comprises an algorithmic calculation module based on a physical model (MP), this module bearing the reference 51 in FIG. 5.

### Learning Operation of the Loss Estimation Module

In advance, tests and measurements on the flow path are carried out on a test vehicle similar to the vehicle of interest. These tests have the aim of carrying out a learning operation of a supervised-learning loss estimation module 52 which will be used on the vehicle of interest.

These learning tests are carried out by means of a series of test injection members having known and varied flow cross section characteristics. The test injection members may have a flow cross section that is smaller than the nominal flow cross section, or, conversely, a flow cross section that is larger than the nominal flow cross section.

One of the test injection members is placed successively as injection member on the test vehicle in order to measure the hydraulic loss introduced by the test injection member. Each of the test injection members is activated and a set of parameters thereof is measured. This set of parameters comprises at least:
Pressure P1
Pressure P0
Jump in pressure dP on closure of the injection member. This jump in pressure is referred to as the “water hammer” in hydraulic jargon. It is a fairly short temporary state.
Temperature of the fluid Tki (TK1, TK2, TK3 measured respectively at different locations).
QMES Measured quantity of fluid effectively injected.

The measured quantity QMES may be effectively measured since these tests are carried out with laboratory means on the test vehicle.

The test injection member simulates non-nominal behavior on the flow path in the vehicle of interest depending on the plurality of parameters.

Each of the test injection members has a different flow cross section so as to fairly broadly cover the range of changes in flow cross section that may be encountered in series vehicles.

In one example, a supervised-learning loss estimation module is used. A test injection member is positioned and the injected quantity and the parameters dP, P1, P0, T are measured. Then, the method starts again with another test injection member. For an output of the estimation module referred to as the hydraulic loss coefficient, denoted CP, a cost function is calculated which is minimized during the learning operation.

Thus, in operating mode, the loss estimation module will take as input said plurality of parameters and will supply as output the hydraulic loss coefficient denoted CP.

The loss estimation module comprises a neural network. The coefficients of the nodes of the neural network are adjusted by the back-propagation learning process based on an error function (cost function). For example, the error function may be based on QMES−CP×QTH

As illustrated in FIG. 1, the size of the neural network is moderate. In terms of structure, the neural network may comprise two hidden layers, with 10 to 12 neurons per hidden layer 42, 43. Generally, the total number of neurons can be chosen to be fewer than 500, preferably fewer than 400. Thus, the calculation time is very short and the repetition frequency of the calculation can be high.

Also, the memory size occupied by the neural network is very modest. The neural network may have a size less than 5 kilobytes and preferably less than 3 kilobytes.

However, the principle of the invention can be used for larger neural network sizes.

### Operational Estimation on Vehicle of Interest

The electronic control unit is configured to implement the following steps of:
/b/—carrying out a plurality of N sequences of fluid injection, during which values of a plurality of parameters (dP, P1, P0, T, X) are collected,
/c/—calculating a theoretical quantity of fluid injected during these N sequences of fluid injection, with the aid of at least some of said values of the plurality of parameters (P1, P0, T, X),
/d/—transmitting, to the loss estimation module, said values of the plurality of parameters (dP, P1, P0, T, X), and obtaining, at the output of the loss estimation module, the loss coefficient CP,
/e/—calculating an estimated actual quantity of fluid injected during the N sequences of fluid injection, by applying the loss coefficient CP to the calculation of the theoretical quantity of fluid.

In step /a/, the values of the different parameters are sampled by the pressure sensors 6, 7 and by the temperature sensor 8. The sampling may be fairly rapid, in particular for the measurement of the pressure P1. Conversely, the temperature measurements do not require rapid sampling.

For the measurement of the pressure P1, in order to pick up the characteristics of the water hammer, the sensor has to be a rapid sensor and the sampling makes it possible to take at least 50 samples per millisecond (at least 50 kHz). According to one example, the sampling makes it possible to take at least 100 samples per millisecond (at least 100 kHz on the sensing and digitization chain). FIG. 8 illustrates an example of an overpressure waveform corresponding to the water hammer on closure of the injector. In reality, the characteristics of this chronogram reflect the state of the flow cross section for the liquid. Optionally, other additional parameters Y may be taken into account, such as the time that has elapsed since the previous series of injections, the outside temperature, the mileage of the vehicle, etc.

According to one example, the theoretical quantity of fluid denoted QTH may be calculated as follows, using a so-called Bernoulli model for an incompressible fluid.

$$QTH = {\sum }_{i = 1}^{N} Ti \sqrt{ρ ( P 1 - P 0 )} A \qquad [ Math 2 ]$$

In this formula:
ρ is the density of the fluid,
P1 is the pressure at the outlet of the pump,
P0 is the pressure in the injected zone 4,
A is a characteristic section of the flow cross section,
Ti is the injection duration, for a control cycle of the injector, of index i,
N is the number of injections.

QTH is a mass quantity. This quantity corresponds to the nominal quantity for a new injector. This calculation corresponds to step /c/ of the promoted method. QTH is calculated by the module MP 51.

It should be noted that the characteristics of the water hammer do not appear in the above formula; the pressure P1 is an average pressure and the jump in pressure only occurs marginally in the above formula.

Conversely, in step /d/, the loss estimation module takes as inputs not only the abovementioned parameters P1, P0 but also characteristics of the jump in pressure dP (water hammer). The characteristics of the jump in pressure dP comprise at least the jump height dP1 and the duration Tr, as is illustrated in FIG. 8.

The loss estimation module, the supervised learning of which has been carried out beforehand, now delivers its output in the form of the loss coefficient CP.

According to a simple example, the estimated actual quantity of injected fluid, denoted QRE, is calculated by multiplying the theoretical quantity of fluid, denoted QTH, by the loss coefficient CP output by the loss estimation module. Therefore, in this case, QRE=CP×QTH.

According to a generic formulation, the estimated actual quantity of fluid is calculated by applying the loss coefficient CP to the calculation of the theoretical quantity of fluid according to a correction function F, as expressed, for example, as follows:

$$QRE = F ( QTH , CP ) .$$

If N injections are carried out, each having an index ‘i’ and a duration Ti, the corrected theoretical and actual quantities (QTH, QRE) are calculated as a summation over the index ‘i’.

If all the Ti are the same, the calculation of QTH is simplified to:

$$QTH = N Ti \sqrt{ρ ( P 1 - P 0 )} A . \qquad [ Math 3 ]$$

In practice, either the average or the median of the values collected over the N injections is taken for P1. Similarly, either the average or the median of the values collected over the N injections is taken for P0. Similarly, either the average or the median of the values collected over the N injections is taken for characteristics of the jump in pressure dP, i.e. dP1 and Tr.

According to one option, an alert is activated if the loss coefficient CP is below a predetermined threshold CPS1. For example, the threshold CPS1 is between 0.5 and 0.75, this value being dependent on the fluid injection member.

The threshold CPS1 advantageously depends on a value of the loss coefficient at the start of life, for example the initial value of the loss coefficient CP, or an averaged value, obtained at the start of life of the fluid injection member when the latter has not yet undergone wear or clogging. For example, the threshold CPS1 is equal to the loss coefficient at the start of life, decreased by a predetermined quantity, for example 20%.

In addition or as a variant, an alert is activated if the loss coefficient CP is above a predetermined threshold CPS2. The threshold CPS2 advantageously depends on said loss coefficient at the start of life. For example, the threshold CPS2 is equal to the loss coefficient at the start of life, increased by a predetermined quantity, for example 20%.

In any event, an alert may be activated if a variation in the value of the loss coefficient CP, after a predetermined number of injections, is above a predetermined variation threshold.

Thus, a diagnostic of an engine system of a vehicle of interest is carried out, making it possible to detect, in advance, a need for maintenance of the fluid injection member (predictive maintenance).

If necessary, steps /c/ of calculating a theoretical quantity of injected fluid and /e/ of calculating an estimated actual quantity of injected fluid are not implemented, only the diagnostic being implemented.

### Control System

The electronic control unit 5 comprises a microcontroller, a nonvolatile memory zone, and analog-digital converters for acquiring the pressure and temperature parameters.

As can be seen in FIG. 1, the electronic control unit 5 comprises at least one output 55 for controlling the coil 13 of the injector.

As shown schematically in FIG. 5, the electronic control unit 5 carries out the calculation of the theoretical quantity injected, on the basis of the opening times Ti. This is depicted as the module 51 that has already been discussed and can be seen in FIG. 5.

Furthermore, the electronic control unit 5 comprises the loss estimation module 52. For each unitary injection cycle or each group of injection cycles, the loss estimation module supplies the loss coefficient CP and the electronic control unit 5 uses this output for, if necessary, generating an alert for the driver or the maintenance service of the vehicle.

The electronic control unit 5 carries out the calculation of the estimated actual quantity (step /e/). The set of steps is illustrated in FIG. 6.

The neural network 40, which is illustrated in FIG. 7, preferably has a simple structure, with a one-dimensional output, in this instance the coefficient CP. The input layer comprises a certain number of parameters X1, X2, X3, Xi, Xm. The number m of inputs may be around 10.

The neural network 40 comprises 1 to 3 intermediate layers 42, 43, also referred to as hidden layers, for example with the same dimension as the input vector.

Thus, the size of the neural network 40 is reduced. For example, the number of nodes may be around 30, and the number of neurons/links in the vicinity of 300, and therefore below 400, as already mentioned above. Each parameter by be stored on 4 bytes, thereby producing the modest memory sizes mentioned above.

### Other Points

The test vehicle may be of the same type as the target vehicles in which the method set out above is used on a large scale. However, it will be noted that the test vehicle may be of a different type than that of the target vehicles, as long as the flow path and the injection member exhibit a certain similarity between the test vehicle and the target vehicles.

1. A method for determining an injected quantity of a fluid of interest in an engine system of a vehicle of interest, said quantity not being measured directly by a sensor, the engine system comprising at least a fluid tank (3), a pump (2), a fluid injection member (1), with a fluid flow path from the pump to an injected zone (4) downstream of the injection member, and an electronic control unit (5) that is able to command opening of the injection member, which is otherwise closed in the absence of a command,
the method comprising the following steps:
providing a supervised-learning (RNN, IA) loss estimation module (52), taking as input a plurality of parameters (dP, P1, P0, T, X) and supplying as output a hydraulic loss coefficient CP relating to a hydraulic loss introduced by the fluid injection member (1),
/b/—carrying out a plurality of N sequences of fluid injection, during which values of said plurality of parameters (dP, P1, P0, T, X) are collected,
/c/—calculating a theoretical quantity (QTH) of fluid injected during these N sequences of fluid injection, with the aid of at least some of said values of the plurality of parameters (P1, P0, T, X), the theoretical calculation using a so-called Bernoulli module for an incompressible fluid,
/d/—transmitting, to the loss estimation module (52), said values of the plurality of parameters (dP, P1, P0, T, X), and obtaining, at the output of the loss estimation module, the loss coefficient CP,
/e/—calculating an estimated actual quantity (QRE) of fluid injected during the N sequences of fluid injection, by applying the loss coefficient CP to the calculation of the theoretical quantity of fluid.

2. The method as claimed in claimed 1, comprising a prior step of:
/a/—carrying out, in advance, a learning operation of the supervised-learning (RNN, IA) loss estimation module by means of a series of test injection members having known flow cross section characteristics, which are placed successively as injection member on a similar flow path of a test vehicle in order to simulate the hydraulic loss introduced by the injection member on the flow path in the vehicle of interest depending on the plurality of parameters, and while measuring, during an opening sequence of the injection member, the values of the parameters of the plurality of parameters, the loss estimation module taking as input said plurality of parameters (dP, P1, P0, T, X) and supplying as output the hydraulic loss coefficient CP.

3. The method as claimed in claim 1, wherein, in step /e/the loss coefficient CP is applied by multiplying it by the calculation of the theoretical quantity (QTH) of fluid in order to obtain the estimated actual quantity (QRE) of fluid injected during the N sequences of fluid injection.

4. The method as claimed in claim 1, wherein the loss coefficient CP is between 0 and 1.

5. The method as claimed in claim 1, wherein an alert is activated if the loss coefficient CP is below a first predetermined threshold and/or above a second predetermined threshold.

6. The method as claimed in claim 1, wherein an alert is activated if a variation in the value of the loss coefficient CP, after a predetermined number of injections, is above a predetermined variation threshold.

7. The method as claimed in claim 1, wherein the loss estimation module comprises a neural network, and preferably the neural network takes up a memory size less than 5 kilobytes.

8. The method as claimed in claim 1, wherein the values of the plurality of parameters (dP, P1, P0, T, X) are filtered and/or smoothed over the N injection sequences for use in the loss estimation module.

9. The method as claimed in claim 1, wherein the plurality of parameters (dP, P1, P0, T, X) comprises a first parameter (dP) representative of an increase in pressure on closure of the injector.

10. A system for determining an injected quantity of a fluid of interest, this fluid of interest flowing in use in an engine system of a vehicle of interest, said quantity not being measured directly by a sensor, the engine system comprising at least a fluid tank (3), a pump (2), a fluid injection member (1), with a fluid flow path from the pump to an injected zone (4) downstream of the injection member, and an electronic control unit (5) that is able to command opening of the injection member, which is otherwise closed in the absence of a command, the fluid of interest being a liquid fluid that is incompressible or exhibits low compressibility, the system comprising a supervised-learning (RNN, IA) hydraulic loss estimation module (52), taking as input a plurality of parameters (dP, P1, P0, T, X) and supplying as output a hydraulic loss coefficient CP relating to a hydraulic loss introduced by the fluid injection member (1), the electronic control unit (5) being configured for:
/b/—carrying out a plurality of N sequences of fluid injection, during which values of said plurality of parameters (dP, P1, P0, T, X) are collected,
/c/—calculating a theoretical quantity (QTH) of fluid injected during these N sequences of fluid injection, with the aid of at least some of said values of the plurality of parameters (P1, P0, T, X), the theoretical calculation using a so-called Bernoulli module for an incompressible fluid,
/d/—transmitting, to the loss estimation module, said values of the plurality of parameters (dP, P1, P0, T, X), and obtaining, at the output of the loss estimation module, the loss coefficient CP,
/e/—calculating an estimated actual quantity of fluid injected during the N sequences of fluid injection, by applying the loss coefficient CP to the calculation of the theoretical quantity of fluid.

11. The system as claimed in claim 10, wherein a learning operation of the supervised-learning (RNN, IA) loss estimation module is provided, prior to effective use, by means of a series of test injection members having known flow cross section characteristics, which are placed successively as injection member on a similar flow path of a test vehicle in order to simulate the hydraulic loss introduced by the injection member on the flow path in the vehicle of interest depending on the plurality of parameters, and while measuring, during an opening sequence of the injection member, the values of the parameters of the plurality of parameters, the loss estimation module taking as input said plurality of parameters (dP, P1, P0, T, X) and supplying as output the hydraulic loss coefficient CP.

12. The system as claimed in either of claim 10, wherein the fluid is a urea-based liquid intended to reduce nitrogen oxides.

13. The system as claimed in claim 10, wherein the injection member is a needle injector.

14. The system as claimed in claim 10, wherein the loss estimation module is in the form of a neural network contained in the electronic control unit (5).

15. A diagnostic method for an engine system of a vehicle of interest, the engine system comprising at least a fluid tank (3), a pump (2), a fluid injection member (1), with a fluid flow path from the pump to an injected zone (4) downstream of the injection member, and an electronic control unit (5) that is able to command opening of the injection member, which is otherwise closed in the absence of a command,
the method comprising the following steps:
providing a supervised-learning (RNN, IA) loss estimation module (52), taking as input a plurality of parameters (dP, P1, P0, T, X) and supplying as output a hydraulic loss coefficient CP relating to a hydraulic loss introduced by the fluid injection member (1),
/b/—carrying out a plurality of N sequences of fluid injection, during which values of said plurality of parameters (dP, P1, P0, T, X) are collected,
/d/—transmitting, to the loss estimation module (52), said values of the plurality of parameters (dP, P1, P0, T, X), and obtaining, at the output of the loss estimation module, the loss coefficient CP,
/e′/ comparing the loss coefficient CP with a predetermined value, and generating an alert if the difference in absolute value exceeds a predetermined threshold.
